(19) United States
(12) Patent Application Publication
(10) Pub. No.: US 2015/0363120 A1
(43) Pub. Date: Dec. 17, 2015

(54) ON DEMAND BLOCK MANAGEMENT

(71) Applicant: MICRON TECHNOLOGY, INC., Boise, ID (US)

(72) Inventors: Yi Chen, Shanghai (CN); Yukiyasu Murakami, Kamakura (JP)

(73) Assignee: MICRON TECHNOLOGY, INC., Boise, ID (US)

(21) Appl. No.: 14/384,446

(22) PCT Filed: Jun. 25, 2013
(86) PCT No.: PCT/CN2013/000753

§ 371 Date: Sep. 11, 2014

(51) Int. Cl. G06F 3/06

(52) U.S. Cl. CPC G06F 3/0617; G06F 3/0619; G06F 3/064; G06F 3/0653; G06F 3/0679

(57) ABSTRACT

Methods and memories for embedded systems, and systems with managed memories, are provided. In one such method, a managed memory determines when housekeeping operations are indicated, conveys that information to a host, and the host initiates the housekeeping operation at a time determined by the host not to affect real-time system operation.

### TECHNICAL FIELD

The present embodiments relate generally to memory devices and a particular embodiment relates to block management in embedded memory devices.

### BACKGROUND

Memory devices (which are sometimes referred to herein as “memories”) are typically provided as internal, semiconductor, integrated circuits in computers or other electronic systems. There are many different types of memory including random-access memory (RAM), read only memory (ROM), dynamic random access memory (DRAM), synchronous dynamic random access memory (SDRAM), and flash memory.

Flash memory devices have developed into a popular source of non-volatile memory for a wide range of electronic applications. Flash memory devices typically use a one-transistor memory cell that allows for high memory densities, high reliability, and low power consumption. Changes in threshold voltage of the cells, through programming of a charge storage structure, such as floating gates or trapping layers or other physical phenomena, determine the data state of each cell. Common electronic systems that utilize flash memory devices include, but are not limited to, personal computers, personal digital assistants (PDAs), digital cameras, digital media players, digital recorders, games, appliances, vehicles, wireless devices, cellular telephones, amusement gaming machines, automotive information and entertainment systems, and removable memory modules, and the uses for flash memory continue to expand.

Flash memory typically utilizes one of two basic architectures known as NOR flash and NAND flash. The designation is derived from the logic used to read the devices. In NOR flash architecture, a string of memory cells is coupled in parallel with each memory cell coupled to a data line, such as those typically referred to as digit (e.g., bit) lines. In NAND flash architecture, a string of memory cells is coupled in series with only the first memory cell of the string coupled to a bit line.

As the performance and complexity of electronic systems increase, the requirement for additional memory in a system also increases. However, in order to continue to reduce the costs of the system, the parts count must be kept to a minimum. This can be accomplished by increasing the memory density of an integrated circuit by using such technologies as multilevel cells (MLC). For example, MLC NAND flash memory is a very cost effective non-volatile memory.

Managed NAND devices such as embedded MultiMediaCard (eMMC), solid state drives (SSD) or other NAND based devices with a controller cannot define their maximum latencies. Instead, latencies are indicated as a typical latency. Typical latencies, however, can be far shorter than actual latencies in such embedded systems. Managed systems often operate on a real-time basis. As such, knowledge of actual latency times for memory operations is desirable. For example, NAND uses algorithms for housekeeping operations such as to maintain error correction, and to move blocks for read disturb avoidance and wear leveling for increased reliability and data retention performance. These algorithms are typically implemented in a controller and/or its firmware. Because the process time/duration of maintenance algorithms varies every time they are invoked, actual latency is difficult to determine.

Usually, the housekeeping operations are controlled by the NAND controller automatically. As such, the timing and duration of moving blocks are determined by the controller. This is typically implemented into the controller hardware itself and/or its firmware. The latency of moving blocks can take hundreds or even thousands of times longer than the typical latency of the NAND. This in turn can affect real-time operation of the system in which the managed memory is embedded.

For the reasons stated above and for other reasons that will become apparent to those skilled in the art upon reading and understanding the present specification, there is a need in the art for improved housekeeping operation in embedded memories.

### BRIEF DESCRIPTION OF THE DRAWINGS

FIG. 1 is a flow chart diagram of a method according to an embodiment of the disclosure;

FIG. 2 is a flow chart diagram of a method according to another embodiment of the disclosure;

FIG. 3 is a flow chart diagram of a method according to yet another embodiment of the disclosure;

FIG. 4 is a flow chart diagram of a cycle count housekeeping method according to an embodiment of the disclosure;

FIG. 5 is a flow chart diagram of a read count housekeeping method according to an embodiment of the disclosure;

FIG. 6 is a flow chart diagram of an error correction threshold housekeeping method according to an embodiment of the disclosure; and

FIG. 7 is a block schematic of an electronic system having an embedded memory device in accordance with an embodiment of the disclosure.

### DETAILED DESCRIPTION

In the following detailed description, reference is made to the accompanying drawings that form a part hereof and in which is shown, by way of illustration, specific embodiments. In the drawings, like numerals describe substantially similar components throughout the several views. Other embodiments may be utilized and structural, logical, and electrical changes may be made without departing from the scope of the present disclosure. The following detailed description is, therefore, not to be taken in a limiting sense.

In a typical managed NAND, in order to achieve reliability in operation, the controller of the managed NAND device usually monitors the NAND, and maintains housekeeping operations such as wear leveling, ECC threshold based refresh, and the like by moving blocks when housekeeping is indicated. In order to move the blocks properly, there are two steps that are typically used, detection and block movement. Detection determines that block movement is indicated. Block movement is the actual movement of blocks following the detection.

Embodiments of the present disclosure provide for operation of housekeeping functions in managed memories by a host for the system in which the memory is embedded. This allows the real-time nature of operation of the system not to be affected by housekeeping operations in the memory. Detection of housekeeping indication is still performed by the NAND, but initiation of the housekeeping operations is controlled by the host of the system.

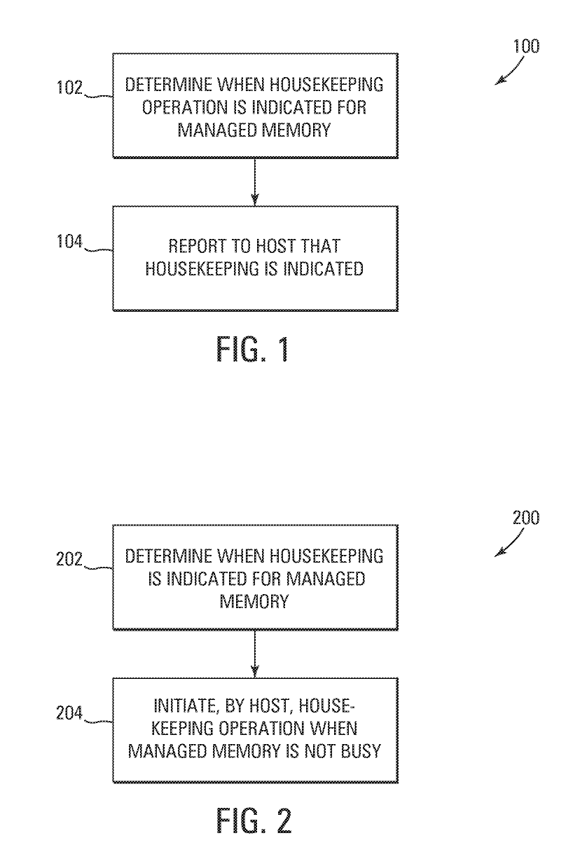

One embodiment of a method 100 of operating a system having a managed memory is shown in FIG. 1. Method 100 comprises, in one embodiment, determining when a housekeeping operation is indicated for the managed memory in block 102, and reporting to a host of the system that the housekeeping operation is indicated in block 104. Once the housekeeping operation is indicated, and that indication is reported to the host, the host initiates the housekeeping operation at the host's discretion. In one embodiment, the host initiates the housekeeping operation when the managed memory is not busy with real-time operations. For example, the housekeeping may be initiated based on a status of the system. Such status may be reported by the managed memory to the host via a physical connection, such as a pin, or through software, such as by a flag bit or bits being set by the memory, when housekeeping is indicated.

Housekeeping is initiated at such time as the host determines that the housekeeping can proceed without affecting real-time operations of the system, for example, at power down or power up of the system. When the system is being powered down, housekeeping operations may be initiated by the host. Such housekeeping operations may be assigned a specific amount of time, or a specific number of block movements, before the system powers down. Should the full amount of housekeeping operations not be completed before power down, the indication of the remaining housekeeping operations that are still to be performed are in one embodiment saved into non-volatile storage. These operations may be completed, for example, at the next power up of the system, or at other idle time of the system, as determined by the host.

Sometimes housekeeping will take a very long time, seconds or more. In such times, the host may limit a total implementation time, or a physical limit such as swapping one or two blocks only, before housekeeping is paused. Information about which swaps or housekeeping tasks have been indicated as required but not yet performed at power-down/shutoff is stored. That is, the current status of blocks/housekeeping is saved to the NAND. At the next power-up, the controller can read out the stored previous status so that housekeeping of the NAND may continue to completion.

An embodiment of another method 200 of operating a system having a managed memory is shown in flow chart form in FIG. 2. Method 200 comprises, in one embodiment, determining when a housekeeping operation is indicated for the managed memory in block 202, and initiating, by a host, the housekeeping operation when the managed memory is not busy in block 204. Housekeeping in one embodiment is initiated based on a status of the system.

In operation, a specific hardware or software interface is used to identify that blocks are to be swapped. This can be done with a specific pin out on a device, or as a flag set in a register. In a hardware interface, a voltage level on a physical pin changes, indicating to the host that wear leveling housekeeping is needed. In a software interface, one bit or several bits may be added in a status report for the device to indicate that housekeeping is necessary. For example, at the same time the status report is provided from the managed NAND to the host, the managed NAND returns status of command as well as the status of the housekeeping. This tells the host that some housekeeping is needed. The host can understand the issue and schedule the housekeeping according to the status of the system.

There are many possible implementations of hardware or software indications that will be apparent to those of skill in the art.

Once the host understands that there is a block swap needed, the host can send a hardware or a software command to the device, via a physical pin for example, or a command in software to the device to execute the particular housekeeping that is needed. Then the controller starts the housekeeping.

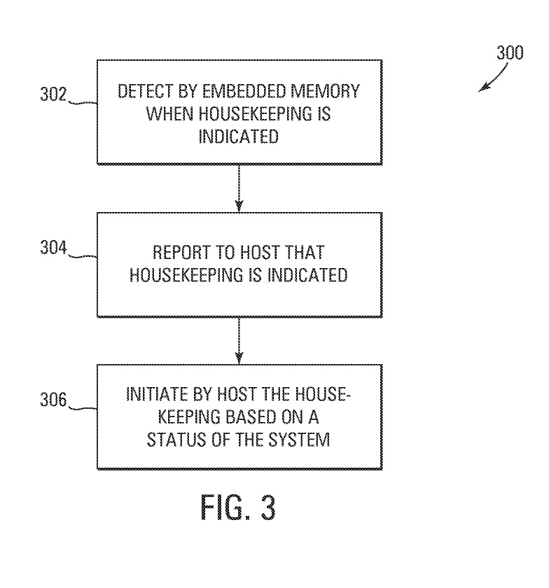

An embodiment 300 of a method of operating an embedded memory in a system is shown in flow chart diagram in FIG. 3. Method 300 comprises, in one embodiment, detecting by the embedded memory when housekeeping in the memory is indicated in block 302, reporting to a host of the system that housekeeping is indicated in block 304, and the host initiating the housekeeping based on a status of the system in block 306. The host initiates the housekeeping in one or more embodiments when the status of the system is such that the system is not using the embedded memory device, for example, when the status of the system is powering up, or when the status of the system is powering down, or when other tasks of the system are operating but the embedded memory system is idle.

As has been mentioned above, reporting to the host that housekeeping is indicated may be performed, in some embodiments, by indicating with a signal on a pin of the embedded memory, or by setting a flag bit or bits in a register of the embedded memory. When the system is powering down, and all housekeeping tasks are not performed before shutdown, an indication that housekeeping is not complete, along with information on what housekeeping has yet to be performed, is stored so that the remaining housekeeping may be performed at a later time, such as at a next power-up of the system.

Detecting when housekeeping in the memory is indicated, as in block 302, is in various embodiments the detection of such housekeeping tasks as cycle count, read count, or error correction threshold in the memory.

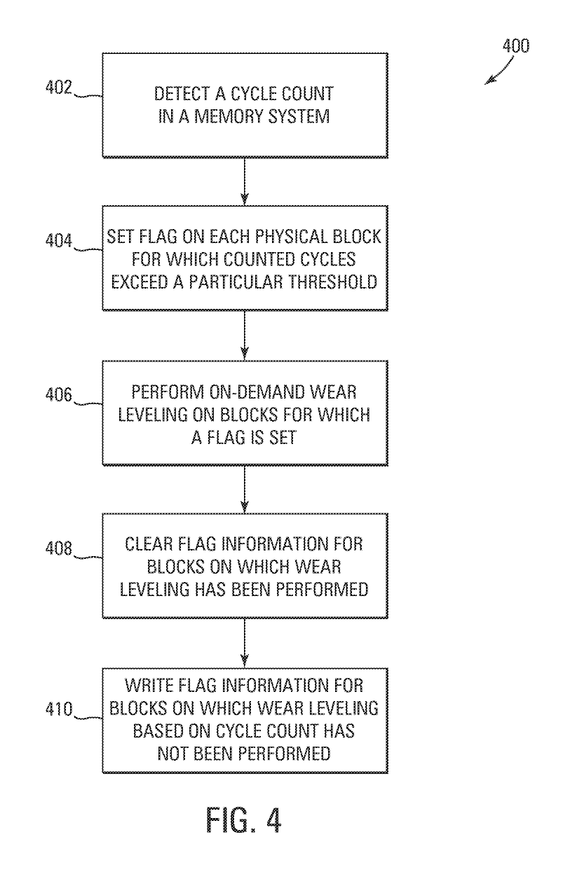

FIGS. 4, 5, and 6 show operation of the system for each of the housekeeping tasks cycle count, read count, and error correction threshold. It should be understood that additional housekeeping tasks may be detected, and additional housekeeping performed, without departing from the scope of the disclosure.

Cycle count housekeeping typically involves count-based wear leveling. In the NAND itself, for each physical block, program and erase cycles are limited. As each physical space is assigned a logical space, large cycle counts on a logical space correspond to large cycle counts of the physical space corresponding to that logical space. When a controller detects a physical space (e.g., a block) with a cycle count that is much higher than other physical spaces, or detects that the physical block has been used very frequently recently, a swap of the physical space assigned to that particular logical space may be indicated. A physical block swap may then be performed, assigning the logical space to a different physical space within the memory. This type of block swap is known. However, as has been mentioned, traditionally when a physical block swap is indicated, the controller of the memory devices determines when to execute the swap. In the present disclosure, however, it is the host of the managed memory that initiates the swap.

FIG. 4 shows a method 400 for performing housekeeping based on a cycle count. Detecting comprises, in one embodiment, detecting a cycle count in the memory system in block 402. Housekeeping based on a cycle count comprises, in one embodiment, wear leveling, and includes setting a flag on each physical block for which counted cycles exceed a particular threshold in block 404, performing on demand wear leveling on blocks for which a flag is set in block 406, clearing flag information for blocks on which wear leveling has been performed in block 4080, and for blocks for which wear leveling based on cycle count is desired, and for which wear leveling is not performed prior to power down, writing the flag information to a non-volatile memory prior to power down in block 410. On demand wear leveling is wear leveling initiated by the host of the system, and at a time the host determines is appropriate for the wear leveling based on, for example, system status. As has been discussed above, at power down of the system, those blocks with indicated wear leveling that have not been swapped have their indications stored for later housekeeping. At power-up of the system, in one embodiment, the system checks for blocks for which flag information indicates wear leveling has not been performed, performs wear leveling during power up of the system for those blocks for which flag information indicates wear leveling has not been performed, and clears flag information for blocks on which wear leveling has been performed.

Read count leveling takes into account basic physics of the device. When a page of the NAND is accessed via a read command, that read command affects (e.g., disturbs) other pages in the same block. For example, in a block with 256 pages, accessing block 0 via a read disturbs pages 1 through 255. No matter what page is accessed, the other pages in the block are subject to disturb. NAND providers typically provide specification on a page level read capability. This number is not a limit for page reads, however. Instead, every page of the block may be read as many times as the specification number. For example, if the page level read capability is set at 100,000, every page in the block may be read 100,000 times. In one embodiment, this is treated as a block level effect, since each page read affects all the other pages of the block. Therefore, in a block with 256 pages, and a 100,000 page level read capability, the total number of page reads is 25,600,000. These page reads are shared in one embodiment over the entire block. If only one page of the memory is accessed, it may be accessed over 25 million times, since each page read affects all the other pages in the same way.

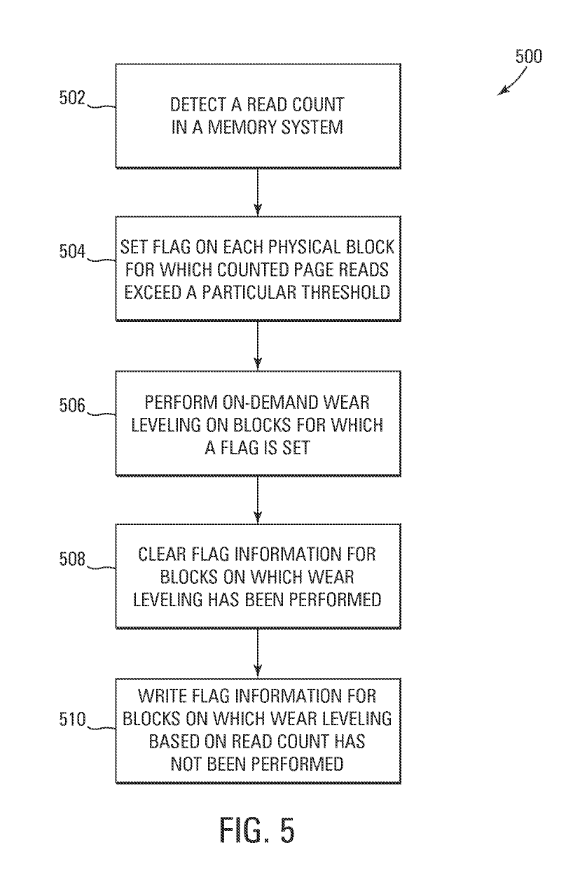

FIG. 5 shows a method 500 for performing housekeeping based on a read count. Detecting comprises, in one embodiment, detecting at least one of cycle count, read count, and error correction threshold in the memory system in block 502. Housekeeping based on a read count comprises, in one embodiment, setting a flag on each physical block for which counted page reads exceed a particular threshold in block 504, performing on demand wear leveling on blocks for which a flag is set in block 506, clearing flag information for blocks on which wear leveling has been performed in block 508, and for blocks for which wear leveling based on read count is desired, and for which wear leveling is not performed prior to power down, writing the flag information to a non-volatile memory prior to power down in block 510. At power-up of the system, in one embodiment, the system checks for blocks for which flag information indicates wear leveling has not been performed, performs wear leveling during power up of the system for those blocks for which flag information indicates wear leveling has not been performed, and clears flag information for blocks on which wear leveling has been performed.

In one embodiment, a read count for a number of a read count threshold for the block is established, based on a determined threshold that is lower than the total number of page reads allowed for the block (e.g., a percentage of 25,600,000). Once the threshold is determined, a count of page reads for each block may be made. The number of page reads for each block is stored, in one embodiment, in a random access memory (RAM) space for its respective block. Such a space may be, in one embodiment, in a RAM space sufficient to store a count up to the threshold, such as a four byte RAM space for a threshold that is a percentage of 25,600,000. Such a RAM space may be a RAM on the memory, or an allocated RAM space for the system, for example. In one embodiment, the threshold is set at approximately 70 percent of the maximum number of page reads. It should be understood that different thresholds may be set without departing from the scope of the disclosure. When the read count threshold is reached for a block, a signal (hardware or software as described above) is sent to inform the host that housekeeping is indicated. Once wear leveling based on read count is performed, the counter for the block that has had its wear leveling performed is reset to zero.

Error correction code (ECC) threshold based refresh is indicated when a certain threshold of errors are detected in a block. Error checking comprises different types such as patrol scrubbing and demand scrubbing. For example, a memory controller in one embodiment in a patrol scrubbing scheme, scans systematically through the memory, detecting bit errors. Erroneous bits can be corrected. Alternatively, when a system tries to read pages according to requirements of the system, and at the same time, the controller identifies how many bits fail in a codeword, housekeeping is indicated. Then, a report is made to the host that housekeeping is indicated. Based on these kind of reports, which as described above may be performed in a hardware or software capacity, the host understands that there is a codeword or codewords with excess fail bits detected. The host then executes housekeeping based on system status of the system as described above.

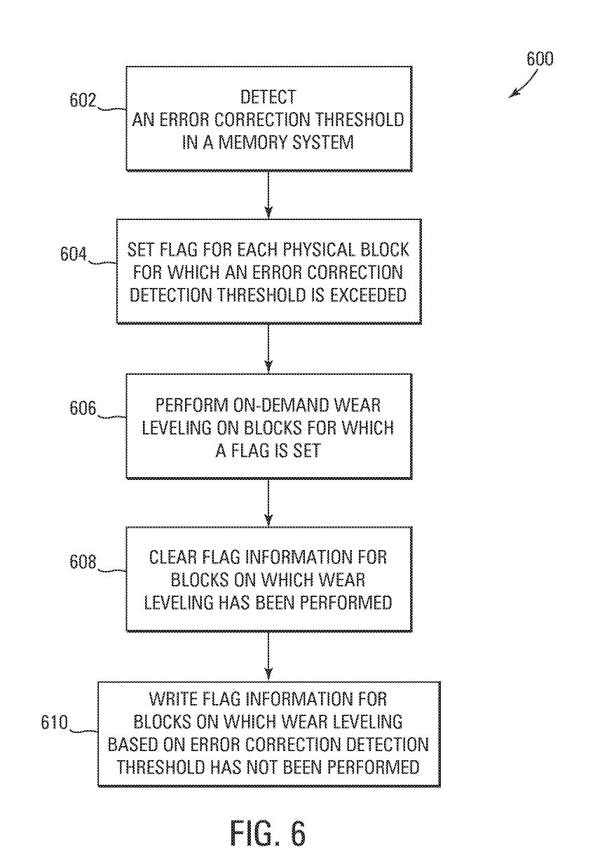

FIG. 6 shows a method 600 for performing housekeeping based on a read count. Detecting comprises, in one embodiment, detecting at least one of cycle count, read count, and error correction threshold in the memory system in block 602. Housekeeping based on an error correction threshold comprises, in one embodiment, setting a flag for each physical block of the memory for which an error correction detection threshold is exceeded in block 604, performing on demand wear leveling on blocks for which a flag is set in block 606, clearing flag information for blocks on which wear leveling has been performed in block 608, and for blocks for which wear leveling based on error correction threshold detection is desired, and for which wear leveling is not performed prior to power down, writing the flag information to a non-volatile memory prior to power down in block 610. At power-up of the system, in one embodiment, the system checks for blocks for which flag information indicates wear leveling has not been performed, performs wear leveling during power up of the system for those blocks for which flag information indicates wear leveling has not been performed, and clears flag information for blocks on which wear leveling has been performed.

Further, at power up of the system in one embodiment, the methods may further comprise checking for blocks for which flag information indicates housekeeping, such as wear leveling, has not been performed, performing housekeeping during power up of the system for those blocks for which flag information indicates housekeeping has not been performed, and clearing flag information for blocks on which housekeeping has been performed.

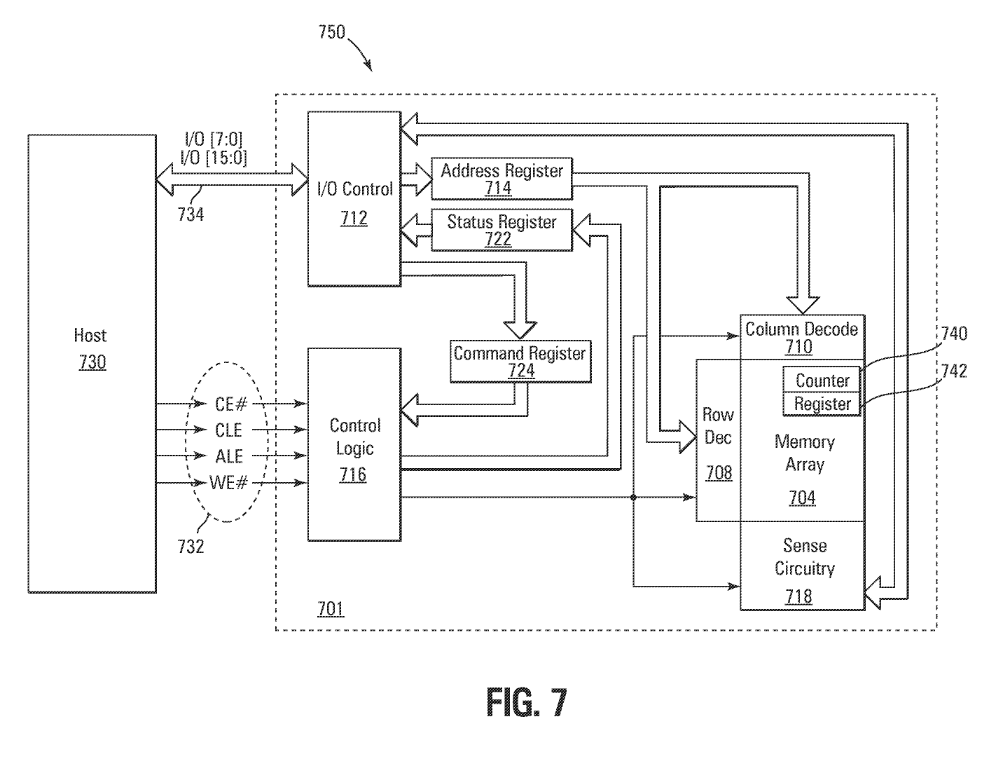

FIG. 7 is a simplified block diagram of an embedded memory device 701 according to an embodiment of the disclosure, and on which various embodiments of the disclosure can be practiced. Memory device 701 includes an array of memory cells 704 arranged in rows and columns. Although the various embodiments will be described primarily with reference to NAND memory arrays, the various embodiments are not limited to a specific architecture of the memory array 704. Some examples of other array architectures suitable for the present embodiments include NOR arrays, AND arrays, and virtual ground arrays. Further, the embodiments described herein are amenable for use with SLC and MLC memories without departing from the scope of the disclosure. Also, the methods are applicable for memories which could be read/sensed in analog format. A counter 740 and/or register 742 are used in one embodiment to track read and cycle counts and error correction threshold information, and to store flag information, as discussed above. It should be understood that multiple counters and registers may be used, such as one for each block, without departing from the scope of the disclosure.

Row decode circuitry 708 and column decode circuitry 710 are provided to decode address signals provided to the memory device 701. Address signals are received and decoded to access memory array 704. Memory device 701 also includes input/output (I/O) control circuitry 712 to manage input of commands, addresses and data to the memory device 701 as well as output of data and status information from the memory device 701. An address register 714 is coupled between I/O control circuitry 712 and row decode circuitry 708 and column decode circuitry 710 to latch the address signals prior to decoding. A command register 724 is coupled between I/O control circuitry 712 and control logic 716 (which may include the elements and code of host 730) to latch incoming commands. In one embodiment, control logic 716, I/O control circuitry 712 and/or firmware or other circuitry can individually, in combination, or in combination with other elements, form an internal controller. As used herein, however, a controller need not necessarily include any or all of such components. In some embodiments, a controller can comprise an internal controller (e.g., located on the same die as the memory array) and/or an external controller. Control logic 716 controls access to the memory array 704 in response to the commands and generates status information for an external host such as a host 730, which in one embodiment is the host of an embedded system. The control logic 716 is coupled to row decode circuitry 708 and column decode circuitry 710 to control the row decode circuitry 708 and column decode circuitry 710 in response to the received address signals.

A status register 722 is coupled between I/O control circuitry 712 and control logic 716 to latch the status information for output to an external controller.

Memory device 701 receives control signals at control logic 716 over a control link 732. The control signals may include a chip enable CE#, a command latch enable CLE, an address latch enable ALE, and a write enable WE#. Memory device 701 may receive commands (in the form of command signals), addresses (in the form of address signals), and data (in the form of data signals) from an external controller over a multiplexed input/output (I/O) bus 734 and output data to an external controller over I/O bus 734. I/O bus 734 is also used in one embodiment to signal physically to the host 730 that housekeeping is indicated.

In a specific example, commands are received over input/output (I/O) pins [7:0] of I/O bus 734 at I/O control circuitry 712 and are written into command register 724. The addresses are received over input/output (I/O) pins [7:0] of bus 734 at I/O control circuitry 712 and are written into address register 714. The data may be received over input/output (I/O) pins [7:0] for a device capable of receiving eight parallel signals, or input/output (I/O) pins [15:0] for a device capable of receiving sixteen parallel signals, at I/O control circuitry 712 and are transferred to sense circuitry (e.g., sense amplifiers and page buffers) 718. Data also may be output over input/output (I/O) pins [7:0] for a device capable of transmitting eight parallel signals or input/output (I/O) pins [15:0] for a device capable of transmitting sixteen parallel signals. It will be appreciated by those skilled in the art that additional circuitry and signals can be provided, and that the memory device of FIG. 7 has been simplified to help focus on the embodiments of the disclosure.

Additionally, while the memory device of FIG. 7 has been described in accordance with popular conventions for receipt and output of the various signals, it is noted that the various embodiments are not limited by the specific signals and I/O configurations described. For example, command and address signals could be received at inputs separate from those receiving the data signals, or data signals could be transmitted serially over a single I/O line of I/O bus 734. Because the data signals represent bit patterns instead of individual bits, serial communication of an 8-bit data signal could be as efficient as parallel communication of eight signals representing individual bits.

Methods for programming may be performed in various embodiments on a memory such as memory device 701. Such methods are shown and described herein with reference to FIGS. 1-6.

### CONCLUSION

In summary, one or more embodiments of the disclosure show management of housekeeping operations in managed or embedded memories. Housekeeping indications are generated by the memory device, and initiated by the host at a time determined by the host to be appropriate not to affect real-time operations of the system.

Although specific embodiments have been illustrated and described herein, it will be appreciated by those of ordinary skill in the art that any arrangement that is calculated to achieve the same purpose may be substituted for the specific embodiments shown. Many adaptations of the disclosure will be apparent to those of ordinary skill in the art. Accordingly, this application is intended to cover any adaptations or variations of the disclosure.

What is claimed is:

1. A method of operating a system having a managed memory, comprising:
determining when a housekeeping operation is indicated for the managed memory; and
reporting to a host of the system that the housekeeping operation is indicated.

2. The method of claim 1, and further comprising the host initiating the housekeeping operation when the managed memory is not busy.

3. The method of claim 1, and further comprising the host initiating the housekeeping operation based on a status of the system.

4. The method of claim 1, wherein reporting to the host comprises reporting with a signal on a pin of the managed memory.

5. The method of claim 1, wherein reporting to the host comprises reporting by setting a flag bit in a register of the embedded memory.

6. The method of claim 1, and further comprising storing an indication that housekeeping is indicated when the system is shut down.

7. The method of claim 6, and further comprising performing housekeeping indicated by the stored indication when the system is powered up.

8. A method of operating a system having a managed memory, comprising:
determining when a housekeeping operation is indicated for the managed memory; and
initiating, by a host, the housekeeping operation when the managed memory is not busy.

9. The method of claim 8, wherein housekeeping is initiated based on a status of the system.

10. A method of operating an embedded memory in a system, comprising:
detecting by the embedded memory when housekeeping in the memory is indicated;
reporting to a host of the system that housekeeping is indicated; and
the host initiating the housekeeping based on a status of the system.

11. The method of claim 10, wherein the host initiates the housekeeping when the status of the system is idle.

12. The method of claim 10, wherein the host initiates the housekeeping when the status of the system is powering down.

13. The method of claim 10, wherein reporting comprises indicating with a signal on a pin of the embedded memory.

14. The method of claim 10, wherein reporting comprises indicating with setting of a flag bit in a register of the embedded memory.

15. The method of claim 10, and further comprising storing an indication that housekeeping is indicated when the system is shut down.

16. The method of claim 15, and further comprising performing housekeeping indicated by the stored indication when the system is powered up.

17. The method of claim 10, wherein detecting comprises:
detecting at least one of cycle count, read count, and error correction threshold in the memory system.

18. The method of claim 17, wherein housekeeping based on a cycle count comprises wear leveling, and comprising:
setting a flag on each block for which counted cycles exceed a particular threshold;
performing on demand wear leveling on blocks for which a flag is set;
clearing flag information for blocks on which wear leveling has been performed.

19. The method of claim 18, and further comprising:
for any blocks for which wear leveling based on cycle count is desired, and for which wear leveling is not performed prior to power down, writing the flag information to a non-volatile memory prior to power down.

20. The method of claim 18, and further comprising:
checking, at power up of the system, for blocks for which flag information indicates wear leveling has not been performed;
performing wear leveling during power up of the system for those blocks for which flag information indicates wear leveling has not been performed; and
clearing flag information for blocks on which wear leveling has been performed.

21. The method of claim 17, wherein housekeeping based on a read count comprises:
setting a flag on each block for which counted page reads exceed a particular threshold;
performing on demand wear leveling on blocks for which a flag is set;
clearing flag information for blocks on which wear leveling has been performed.

22. The method of claim 21, and further comprising:
for any blocks for which wear leveling based on read count is desired, and for which wear leveling is not performed prior to power down, writing the flag information to a non-volatile memory prior to power down.

23. The method of claim 21, and further comprising:
checking, at power up of the system, for blocks for which flag information indicates wear leveling has not been performed;
performing wear leveling during power up of the system for those blocks for which flag information indicates wear leveling has not been performed; and
clearing flag information for blocks on which wear leveling has been performed.

24. The method of claim 21, wherein a read count of page reads within each block is maintained in a random access memory (RAM) space for its respective block.

25. The method of claim 24, wherein the read count is maintained in a four byte RAM space.

26. The method of claim 21, wherein the particular threshold is approximately 70 percent of a maximum read capability of the block.

27. The method of claim 24, and further comprising resetting to zero the read count for each block for which wear leveling based on read count has been performed.

28. The method of claim 17, wherein housekeeping based on an error correction threshold comprises:
setting a flag for each physical block of the memory for which an error correction detection threshold is exceeded;
performing on demand wear leveling on blocks for which a flag is set;
clearing flag information for blocks on which wear leveling has been performed.

29. The method of claim 28, and further comprising:
for any blocks for which wear leveling based on error correction threshold detection is desired, and for which wear leveling is not performed prior to power down, writing the flag information to a non-volatile memory prior to power down.

30. A method of operating an embedded memory in a system, comprising:
detecting when block movement is indicated due to housekeeping concerns in the memory; and
triggering block movement with a host of the system when the host determines that block movement may be accomplished without affecting real-time system operation.

31. A memory device, comprising:
an array of memory cells and a controller, the controller configured to control operation of the array of memory cells, the controller further configured to determine when a housekeeping operation is indicated for the managed memory, and to report to an external host that the housekeeping operation is indicated.

32. The memory device of claim 31, wherein the controller is further configured to initiate the housekeeping operation in response to an initiation command from the external host.

33. The memory device of claim 31, wherein the memory device further comprises a report pin, and the controller is further configured to report to the host with a signal on the report pin.

34. The memory device of claim 31, wherein the memory device further comprises a flag bit for each block of the memory, the flag bit storing an indication for its block indicating when housekeeping is indicated, and wherein the controller is further configured to report to the host when a flag bit in a block indicates that housekeeping is indicated.

35. A system, comprising:
a host configured to generate host control signals; and
an embedded memory device coupled to the host and configured to operate in response to the host control signals, the embedded memory device further configured to determine when a housekeeping operation is indicated for the embedded memory, and the host to initiate the housekeeping operation when the managed memory is not busy.

36. The system of claim 35, wherein the host is configured to initiate the housekeeping based on a status of the system.

37. The system of claim 35, wherein the host is configured to initiate the housekeeping when the status of the system is idle.

38. The system of claim 35, wherein the host is configured to initiate the housekeeping when the status of the system is powering down.

39. The system of claim 35, wherein the host is further configured to store in a non-volatile memory an indication that housekeeping is indicated when the system is shut down and housekeeping is not complete.

40. The system of claim 39, wherein the host is further configured to initiate housekeeping indicated by the stored indication when the system is powered up.

41. A managed memory device, comprising:
an array of memory cells; and
a controller, the controller configured to accept commands from a host, the controller determining when a housekeeping operation is indicated for the managed memory device, and reporting to the host that the housekeeping operation is indicated.

42. The managed memory device of claim 41, wherein the controller is configured to set a flag when housekeeping operation is indicated, and to initiate housekeeping on receipt of a command from the host.
